(19) United States
(12) Patent Application Publication
(10) Pub. No.: US 2004/0002875 A1
(43) Pub. Date: Jan. 1, 2004

(54) System and method for improved insurance marketing

(76) Inventor: Morgan Armstrong, Columbia, SC (US)

Correspondence Address: MCNAIR LAW FIRM, P.O. BOX 10827, GREENVILLE, SC, 29603-0827, US

(21) Appl. No.: 10/405,022

(22) Filed: Apr. 1, 2003

Related U.S. Application Data
(60) Provisional application No. 60/369,015, filed on Apr. 1, 2002.

(51) Int. Cl. G06F 17/60

(52) U.S. Cl. 705/4

(57) ABSTRACT

This invention is a system and method for determining the most advantageous life insurance policy between Individual Preferred Term (IPT) and Voluntary Group Term Life (VGTL) according to the VGTL terms and conditions and employee information. A set of computer readable instructions contained within the computer readable medium receives VGTL information from the target company, receives employee information representing each employees participating in the VGTL plan, contains IPT information representing IPT premiums and benefits, calculates premiums or benefits according to the VGTL information, calculates IPT premiums or benefits for at least one employee according to the employee information and the IPT information, compares premiums or benefits according to the VGTL information and the IPT information and, presenting the comparison so that the determination of whether the VGTL or the IPT plan is most beneficial to the employee.

### CROSS-REFERENCE TO RELATED APPLICATION

This application claims priority on provisional patent application Serial No. 60/369,015, entitled System and Method for Improved Insurance Marketing, filed Apr. 1, 2002.

### FIELD OF THE INVENTION

This invention is directed to a system and method for marketing insurance, specifically, a system for analyzing the life insurance coverage of existing employees of a target company under voluntary group term life plans, performing a comparative analysis with individual preferred term policies, and presenting the results of the analysis to individuals on a company wide basis.

### BACKGROUND OF THE INVENTION

In today's workplace, the ability of a company to attract and retain valuable employees is now more important that ever. On method of attracting and retaining employees is by increasing the quality and quantity of available benefits. Traditionally, benefits provided to the employee include life insurance, health insurance, stock purchase plans, ESOPs, and retirement plans such as the familiar 401K and disability insurance. One attempt to improve benefits for an employee is shown in U.S. Pat. No. 4,648,037. This reference discloses an attempt to improve the manner that information concerning the employee's benefits is communicated. The employee may access information specific to that employee so as to be provided with an up-to-date status of the employee's benefits. However, this reference only manages the current benefit plan in place and does not claim or disclose the ability to analyze benefits to determine whether an improvement in the benefit plan quality can be achieved.

When selecting a benefits package for its employees, a company must balance the benefit provided to the employee with the cost of providing the benefit to the company. It is certainly possible for the cost of a premier benefits package to be cost prohibitive to the company. While securing and retaining employees is of the up most importance, it cannot be achieved at the cost of the company's financial health. Therefore, companies continually review benefit options to determine the best choice for the employee and company based upon the balance between the benefits to be offered and the associated costs. U.S. Pat. No. 6,009,402 is directed to one such system for assisting a company to determine whether to utilize a self-insurance plan or not. This reference, however, is only concerned with the decision for the company without regard to the employee.

Many companies provide Voluntary Group Term Life (VGTL) Insurance as part of the compensation package given to employees. This type of life insurance allows the employee to purchase additional life insurance over and above any provided by the company itself. For example, a company may provide life insurance to an employee equal to 1½ times the employee's salary. However, the employee may wish to have 5 times the employee's salary. Through the VGTL plan, the employee can purchase additional insurance through the companies plan. The benefit of using a VGTL plan is that evidence of good health is typically not required so that all employees are generally entitled to coverage. Accordingly, the premiums paid for the VGTL reflect the fact that the health of each insured is unknown and as such, the premiums are adjusted upwards. Premiums are generally based upon a 5-year age bracket with costs rising as the employee ages into the new bracket. Additionally, premium calculations are made with treating males and females alike, smokers and non-smokers alike, healthy and “un-healthy” individuals alike, all while including the group's history. Simply, the rates are blended across the participant's without consideration to individual circumstances. Individuals typically enroll in the VGTL plans since they are convenient, do not require medical questions, are represented as “inexpensive” insurance, and premiums can be automatically deducted from payroll. However, the VGTL benefit is not advantageous to everyone.

In contrast to securing insurance through VGTL, there is also the ability of an employee to secure Individual Preferred Term (IPT) Life Insurance to supplement the coverage provided by the employer. Unfortunately, the IPT option is rarely presented to employees. Traditionally, the VGTL plan is the only option provided to employees since most personal departments are only familiar with the VGTL option. This is unfortunate because there is a portion of the employees that can achieve a substantial savings by using IPT insurance to supplement the company provided insurance rather than the VGTL. Traditionally, the analysis for discovering and presenting any savings or advantages to the employee has been laborious, time consuming and economically prohibitive for companies to perform. Traditionally, the analysis and calculations are extensive as they must be performed for each employee individually. Therefore, providing an analytical method and system for comparing VGTL plans with IPT policies for each individual in a company is a problem to which considerable attention should be directed.

Accordingly, it is an object of this invention to provide a system and method for analyzing a group of employees to determine the saving under IPT policies rather than VGTL policies for supplemental life insurance.

It is another object of this invention to provide a system and method for analyzing insurance benefits for a large number of employees in a timely and cost efficient manner.

It is another object of this invention to collect information from the employee base to facilitate continued marketing and education of the employees.

### SUMMARY OF THE INVENTION

The above objectives are accomplished by providing a system for analyzing insurance premiums to determine a more beneficial insurance plan for an employee, and more specifically, to a system for determining the benefits to employee of Individual Preferred Term (IPT) life insurance policy over the insurance benefits provided by a Voluntary Group Term Life (VGTL) plan. The determination is made according to the VGTL terms and conditions and employee information of a target company. The invention comprises a computer readable medium, a database contained within the computer readable medium containing term life insurance or IPT information, term life premium information and term life benefits information representing individual term life insurance policies, a set of computer readable instructions contained within the computer readable medium for receiving individual employee information, storing the employee information within the computer readable medium, receiving group life insurance or VGTL information, having group premium information and group benefits information associated with the group life insurance policies, storing the group life insurance information in the computer readable medium, retrieving term life insurance benefits or premium information associated with the term life insurance information at a level corresponding to premium amounts or benefit amounts of the group life insurance information according to the employee information and the term life insurance information, providing a comparison of life insurance benefits or premiums for a group premium or benefit amount of the group life insurance and the term life insurance benefits or premiums so that the employee can be shown which life insurance policy is the most advantageous to the employee.

The computer readable instructions can also include instructions for retrieving the employee information from the computer readable medium and providing a term life insurance policy application according to the employee information so that the employee can apply for the term life insurance. The computer readable instructions can also include instructions for transmitting the term life insurance policy application, electronically or otherwise, to an underwriting entity so that the application can be processed by the underwriting entity.

In a preferred embodiment, the set of computer readable instructions contained within the computer readable medium can include instructions for calculating the present premiums according to the VGTL information, calculating IPT premiums for at least one specific employee according to the employee information and the IPT information, performing a comparison of these premiums, and presenting the comparison so that the determination of whether the VGTL or the IPT plan is most beneficial to the specific employee.

The above objectives are further accomplished by providing a method for analyzing insurance from term life insurance information to determine a more beneficial insurance plan for an employee, comprising the steps of receiving individual employee information, receiving group life insurance information having group premium information and group benefits information, determining insurance benefits or premiums of an individual term life insurance policy according to the group premiums or group benefits of the group life insurance information, the employee information, and the term life insurance information, and providing a comparison of term life insurance benefits or premiums for a group premium amount or a group benefit amount of the group life insurance and the group life insurance so that the employee can be shown which life insurance policy is the most advantageous for the employee.

The method further includes the step of creating a term life insurance policy application according to the employee information so that the employee can apply for the term life insurance, transmitting the term life insurance policy application, electronically or otherwise, to an underwriting entity so that the application can be processed, and providing a term life insurance policy to the employee upon approval of the term life insurance policy application.

In a preferred embodiment, the method for determining the benefits of an IPT policy over the existing VGTL plan according to VGTL information and employee information of a target company can also be determined by the steps of receiving VGTL information from the target company, receiving employee information representing each employees participating in the VGTL plan, receiving IPT information representing IPT premiums, calculating the present premiums according to the VGTL information, calculating IPT premiums for at least one specific employee according to the employee information and the IPT information, performing a comparison of present premiums according to the VGTL information and the IPT premiums for at least one specific employee according to the employee information and the IPT information, and presenting the comparison so that the determination of whether the VGTL or the IPT plan is most beneficial to the specific employee. Additionally, the employee information can be stored for subsequent retrieval.

### DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a flowchart illustrating the steps taken by this invention;

FIG. 2 is a schematic illustrating data collection and dataflow of this invention;

FIG. 3 is a flowchart illustrating the steps taken in this; and,

FIG. 4 is a schematic of this invention showing dataflow at each respective stage.

### DETAILED DESCRIPTION OF THE PREFERRED EMBODIMENT

The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated. An object or module is a section of computer readable code embodied in a computer readable medium that is designed to perform a specific task or tasks. Actual computer or executable code or computer readable code may not be contained within one file or one storage medium but may span several computers or storage mediums. The term “host” and “server” may be hardware, software, or combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The present invention is now described more fully herein with reference to the drawings in which the preferred embodiment of the invention is shown. This invention may, however, be embodied any many different forms and should not be construed as limited to the embodiment set forth herein. Rather, these embodiments are provided so that this disclosure will be thorough and complete and will fully convey the scope of the invention to those skilled in the art.

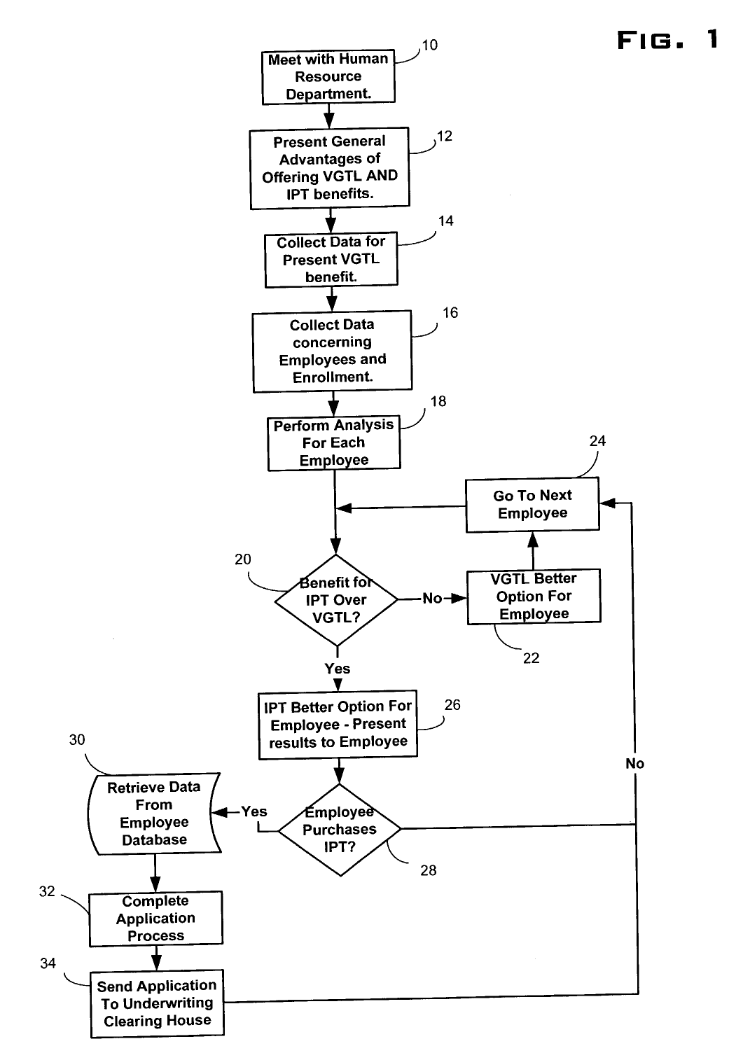

Referring now to FIG. 1, the process for performing the invention is illustrated. The first step is to meet with a representative of the target company that is generally the Human Resources director as shown in step 10. However, many companies have specific individuals in charge of benefits who can be contacted as well. Once reaching the proper representative, general information is presented to illustrate the benefits of the invention at step 12. Once the company representative decides to take advantage of the benefits of this invention, data is collected from the company concerning the current VGTL plan at step 14. Information concerning the VGTL plan can include the group premiums and group benefits under the plan and can be employee specific. Next, data is collected concerning the employees of the company at step 16 as further described herein. Upon collecting the data, the analysis comparing VGTL with IPT for each employee is performed in step 18. The process of performing the analysis is also described herein. Once the analysis is performed in step 18, results are produced that compare the benefits of each employee supplementing life insurance with a VGTL plan or through IPT policies. The determination of whether the IPT contains a benefit over the VGTL for the employee is made at step 20. Benefits can include lower premiums for the same amount of coverage or higher coverage for the same premium price as discussed below. If the IPT does not contain a benefit over the VGTL, then the employee may be better off with the VGTL plan in step 22 and the employee should remain with the present VGTL plan. The analysis proceeds to the next employee for review in step 24. If the next employee does benefit from the IPT policy in step 20, the benefits of the IPT over the VGTL are presented to the employee in step 26. The presentation and providing of the comparison can take multiple forms including written correspondence, physical meeting, telephone communications, electronic presentations, or other methods of conveying this information. Upon receiving the information illustrating the benefits of IPT over VGTL, the employee may decide to purchase an IPT policy at step 28. If so, the specific employee's information is retrieved from the employee data gathered in step 16 in step 30. This ability allows the information to be directly provided to the agent providing the IPT policy rather then have the employee provide such information again, thereby streamlining and even automating the IPT application process. In fact, the IPT application can even be automatically generated, at least in part, by this invention. Any further information is gathered in step 32 or any changes in the retrieved information are made. Upon completion, the application is sent, electronically or otherwise, to the Underwriting Clearing House for processing at step 34.

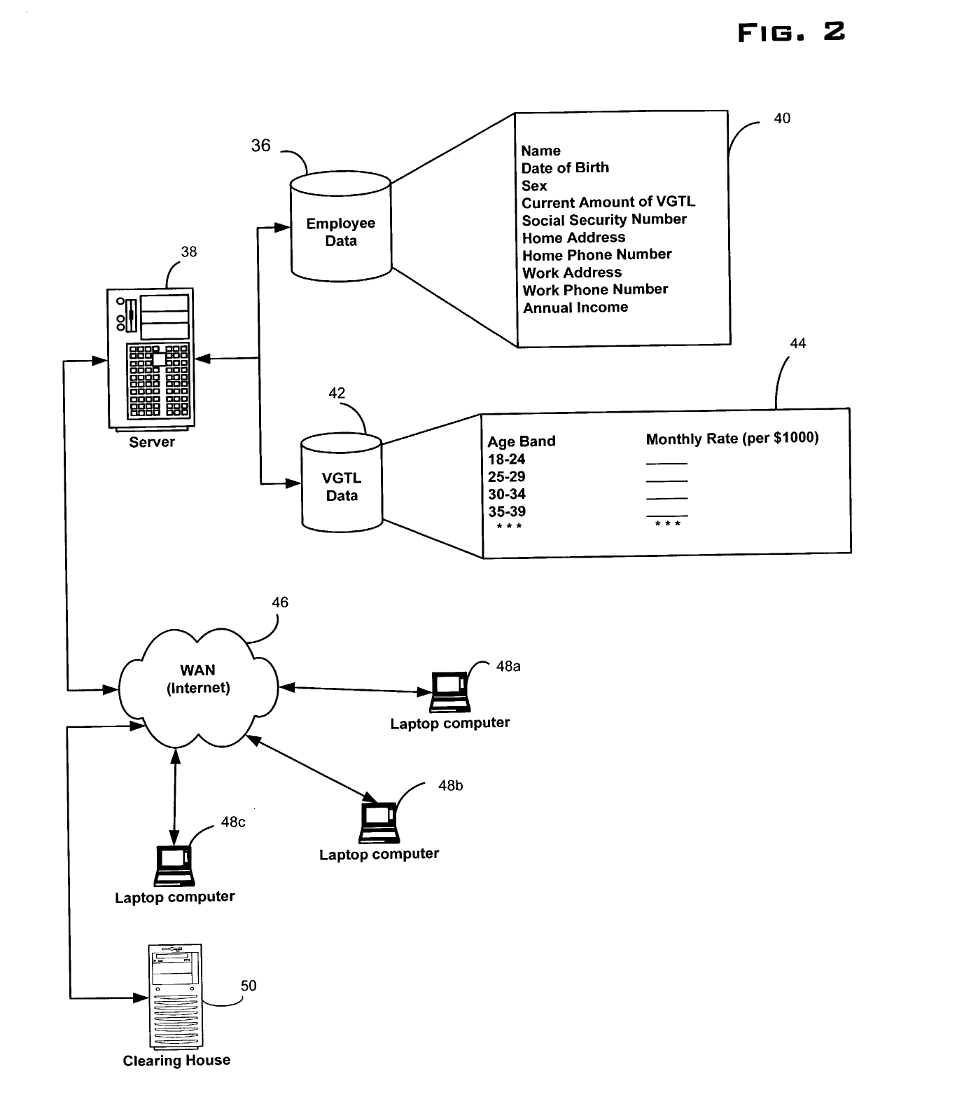

Referring now to FIG. 2, the data collected from the target company is shown in more detail. Employee data 36 is shown embodied in a database in electronic communication with a server 38 having a computer readable medium and a set of computer readable instructions. The information can be supplied by the target company in an electronic format or else subsequently placed into an electronic format. The employee information can include, but is not limited to, the data shown at 40 that includes name, data of birth, and sex. Further, VGTL data 42 is collected from the target company and can include data 44 having the rates for the VGTL benefit per age band for the participants of the present VGTL plan. As shown in FIG. 1, once the data is collected and optionally stored at server 38, the analysis is performed for each employee, thereby creating the results of whether IPT policies provide an advantageous benefit to the employee. This analysis can be performed on server 36 and the results can be transmitted to agents through a Wide-Area-Network (WAN) 46 such as the Internet. Agents, using remote terminals 48a through 48c, can complete an application for the employees wishing to purchase IPT policies, retrieve employee data from server 38 and transmit such policies to a Clearing House system 50. Alternatively, portions of the invention can reside on each of the agent's terminals 48(a) through 48(c) so that the agent can perform the analysis of the target company's employees locally.

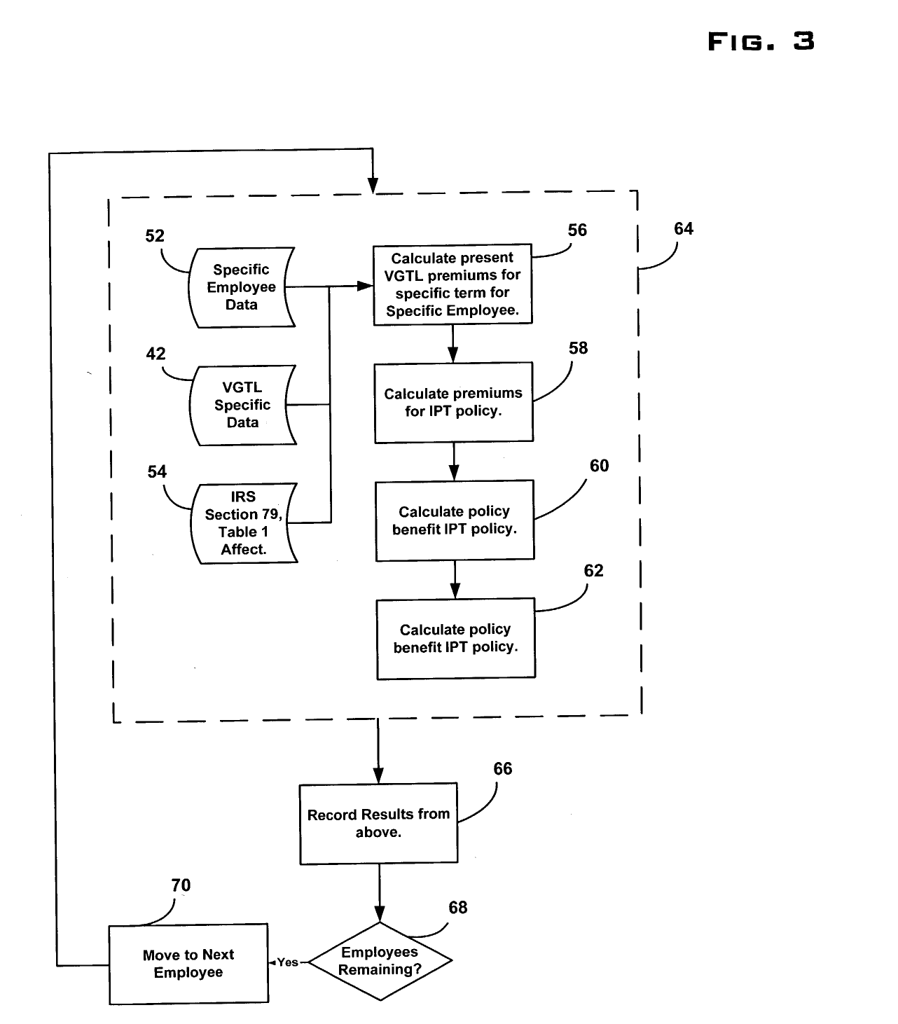

Referring now to FIG. 3, the process for practicing this invention is explained in more detail. Individual employee data 52 forms the initial point for starting the analysis for the present invention. In order to better explain this invention, a specific example will be used but which should in no way limit the scope or applicability of this invention. In the individual employee data, sex, age and coverage amount is included. In the specific example, these values are sex —male, age—35, and coverage amount, or group benefit information, $724,000 as shown in Table 1.

TABLE 1

Employee A

| | |
|---|---|
| Sex | Male |
| Age | 35 |
| VGTL Coverage | $724,000 |
| Amount | |

Again, in the specific example, the following rates were collected from the target company for the VGTL benefit plan in place and included in the group life insurance information.

TABLE 2

Current VGTL Rates

| | Monthly Rate | Annual Rate |
|---|---|---|
| Age Band | Divided by 1000 | Divided by 1000 |
| 18-24 | $0.084 | $1.01 |
| 25-29 | $0.084 | $1.01 |
| 30-34 | $0.096 | $1.15 |
| 40-44 | $0.220 | $2.64 |
| 45-49 | $0.395 | $4.75 |
| 50-54 | $0.671 | $8.05 |
| 55-59 | $1.114 | $13.37 |
| 60-64 | $1.529 | $18.35 |
| 65-69 | $2.376 | $28.51 |
| 70-74 | $2.376 | $28.51 |
| 75+ | $2.376 | $28.51 |

By using the above information, the current group premium schedule can be illustrated for Employee A to show the annual group premiums that Employee A is presently paying for the VGTL through the present plan. In the following table, the premiums are shown, annually, for the present group plan with a total cost for the next fifteen years of enrollment in the column labeled “Current Costs.” The use of the next fifteen years for enrollment is relevant since the IPT plan being used for comparison is a 15-year term policy. However, clearly such analysis can be performed for any term of any IPT policy. Under our example, Employee A would be paying a total of $33,405 for a life insurance term policy ugh VGTL with group benefits of $724,000 of coverage.

TABLE 3

| | | Current | Pre- | | | |
|---|---|---|---|---|---|---|
| Year | Age | Costs | ferred + | Preferred | Select | Standard |
| 1 | 35 | $1,338 | $450 | $494 | $581 | $783 |
| 2 | 36 | $1,338 | $450 | $494 | $581 | $783 |
| 3 | 37 | $1,338 | $450 | $494 | $581 | $783 |
| 4 | 38 | $1,338 | $450 | $494 | $581 | $783 |
| 5 | 39 | $1,338 | $450 | $494 | $581 | $783 |
| 6 | 40 | $1,911 | $450 | $494 | $581 | $783 |
| 7 | 41 | $1,911 | $450 | $494 | $581 | $783 |
| 8 | 42 | $1,911 | $450 | $494 | $581 | $783 |
| 9 | 43 | $1,911 | $450 | $494 | $581 | $783 |
| 10 | 44 | $1,911 | $450 | $494 | $581 | $783 |
| 11 | 45 | $3,432 | $450 | $494 | $581 | $783 |
| 12 | 46 | $3,432 | $450 | $494 | $581 | $783 |
| 13 | 47 | $3,432 | $450 | $494 | $581 | $783 |
| 14 | 48 | $3,432 | $450 | $494 | $581 | $783 |
| 15 | 49 | $3,432 | $450 | $494 | $581 | $783 |
| | TOTAL | $33,405 | $6,757 | $7,408 | $8,711 | $11,752 |
| | SAVINGS | | $26,649 | $25,997 | $24,694 | $21,653 |

In TABLE 3, the year and age of the Employee A is shown in columns 1 and 2 respectively. The cost of the present VGTL plan is shown in column 3 based upon the group life insurance information gathered from the target company and the employee information. The remaining four column, Preferred +, Preferred, Select and Standard, are classification of individuals based upon a determination of the risks associated with the potential insured and are contained within the term life insurance information. The specific calculation to determine the premium for each category is well known within the insurance industry and each insurance industry has proprietary systems and actuary tables for calculating such term life premiums and benefits. However, some common factors used to determine the term life premiums of an IPT policy include information such as lifestyle, health and occupation. In our specific example, Employee A, were he to classify into the Preferred+classification, would received a saving on premiums of approximately 80% or $26,649 per year for a fifteen year period with IPT over VGTL. This is due to two considerations. First, the term life premiums of an IPT policy reward those individuals that are in reasonable good heath and secondly, the term life premium are static for the term of the policy. In contrast, VGTL premiums increase every five years, in our example, and the IPT term of fifteen years would maintain the same premium for the life of that policy.

In order to reach these results, FIG. 3 illustrates the steps taken. Specific employee data 52 is retrieved from employee data 36 from the target company and can be stored electronically. VGTL data 42 specific to the target company is also retrieved and can be stored. In the event that there are pre-tax and after-tax considerations, this information is also retrieved as part of VGTL data 42. The reason being that if VGTL is part of a pre-tax deduction from payroll of a company, the IRS may tax this benefit from the company as income. By using pre-tax dollars for premiums, a tax event may be created which affect the total costs of the VGTL insurance to the employee. The rates that the employee must pay for the “income” generated by providing pre-tax VGTL benefits is generally governed by Section 79, Table 1 of the IRS regulations as shown as 54. Based upon this information, this invention calculates the present total outlay for premiums for the current VGTL plan according to group life insurance information received from the company. Instructions embodied in a computer readable medium perform these calculations shown at step 56. Once the total outlay for the VGTL plan is calculated, a comparison is made to see if the employee can benefit from an IPT policy.

At this point, two calculations can be performed. First, a comparison as to the cost of an IPT policy based upon the same coverage amount as well as a calculation of the coverage amount that the present premium would provide with an IPT policy. In step 58, calculations are made, based upon known IPT criteria, as to what the premium would be for the coverage amount of the VGTL policy to that specific employee. In our example, Employee A is presently paying $1,338 per month for $724,000 worth of life insurance coverage under the VGTL policy. If Employee A was in the highest classification for risk. Employee A would only be paying $494 per year if he were to purchase an IPT policy rather than use VGTL. Clearly, Employee A is much better off with IPT. Additionally, the amount of coverage of an IPT policy based upon the current premium being paid is calculated, as known in the art, in step 60. Therefore, the policy coverage for an IPT policy based upon a premium matching the current VGTL plan can be determined for the specific employee. In our example, Employee A would be able to afford a $2,085,406 policy paying $1,338 per month under an IPT policy. There is also an additional benefit to the employee that is determined at step 60. In the event that the IPT policy is for a specific term that is longer than 5 years, the employee, under the IPT policy would not have the premiums raised for the life of the policy. So while the premiums of the VGTL policy would rise periodically, the premiums of the IPT would be constant for that term. In our example, Employee A would not only be able to increase the coverage amount to $ 2,085,406 while maintain the same premium, but would also save approximately $13,000 over fifteen years.

In order to provide the employee with the most information, the comparison of the present VGTL plan with a proposed IPT plan is performed for the other risk levels that are considered with IPT plans at step 62. The results of step 62 are achieved by assuming that the employee would fall within one of the classifications, determining the premium for that classification, and comparing that premium to the current VGTL payments. Therefore, the employee can be shown to have savings even when the employee does not fall within the most beneficial classification.

While the processes and computer readable instructions 64 (FIG. 3) illustrate the steps for a specific individual, it is advantageous to have these steps performed for all employees to show the target company collectively. When approaching the representative of the target company, showing that the representative can provide a substantial benefit to the employees as a whole allows the target company to more willingly embrace the benefits from the invention for those employees who benefit with IPT policies rather than under the VGTL plan. Therefore, the steps in 64 are recorded for each employee at step 66 and if any employees are remaining at step 68 for which the analysis have not been performed, the calculations are performed for the next employee at step 70. Upon the exhausting of every employee, the results can be generated in a tabular format for easy of presentation to the target company as shown below in

TABLE 4

| | | | Current VGTL Plan | | | PIPT 15 Term | | | $ Savings | | % Savings | |
|---|---|---|---|---|---|---|---|---|---|---|---|---|
| Name | Sex | Age | Amount | Initial | 15-Yrs | Amount | Initial | 15 | Initial | 15 | Initial | 15 |
| A | M | 35 | 724,000 | 1,338 | 33,405 | 724,000 | 494 | 7,408 | 844 | 25,997 | 63% | 78% |
| B | F | 42 | 704,000 | 1,859 | 69,426 | 704,000 | 672 | 10,073 | 1,187 | 59,352 | 64% | 85% |

* * *

| | | | | | | | | | | | | |
|---|---|---|---|---|---|---|---|---|---|---|---|---|
| AA | F | 34 | 20,000 | 23 | 851 | 100,000 | 96 | 1,440 | −73 | −589 | −317% | −69% |

Advantageously, this invention allows representatives of the company to clearly and plainly see that the proposed IPT policies carry significant benefits over the present VGTL plan. The above presentation of the analysis of the invention also allows the company to identify individual employees who would benefit from an IPT policy over the present VGTL plan and provide a means to taken advantage of the IPT policy. Such ability provides a powerful tool for both the agent and the target company representative to identify and provide a benefit to the employees of the target company. Additionally, it can be shown what increased in coverage would result under an IPT policy rather than a VGTL policy for the same premium amount. Such information can also be presented collectively in a format similar to that of Table 4.

It should be noted that in step 52, the specific employee data could also, in an alternative embodiment, contain “what-if” information concerning the employee being analyzed. For example, in TABLE 4, Employee M presently is carrying $20,000 of coverage under the current VGTL plan. It is possible that this particular employee wishes to have coverage in excess of $20,000, but the premiums under the VGTL plan were cost prohibitive. By using this invention, the employee can be shown that merely increasing the premiums by $73 per year, the employee can receive $100,000 worth of coverage while only realizing a $589 in increased in premiums over 15 years. Such “what-if” games are now easily to perform since the necessary information has already been provided and the invention need only the desired amounts to perform the “what-if” calculations.

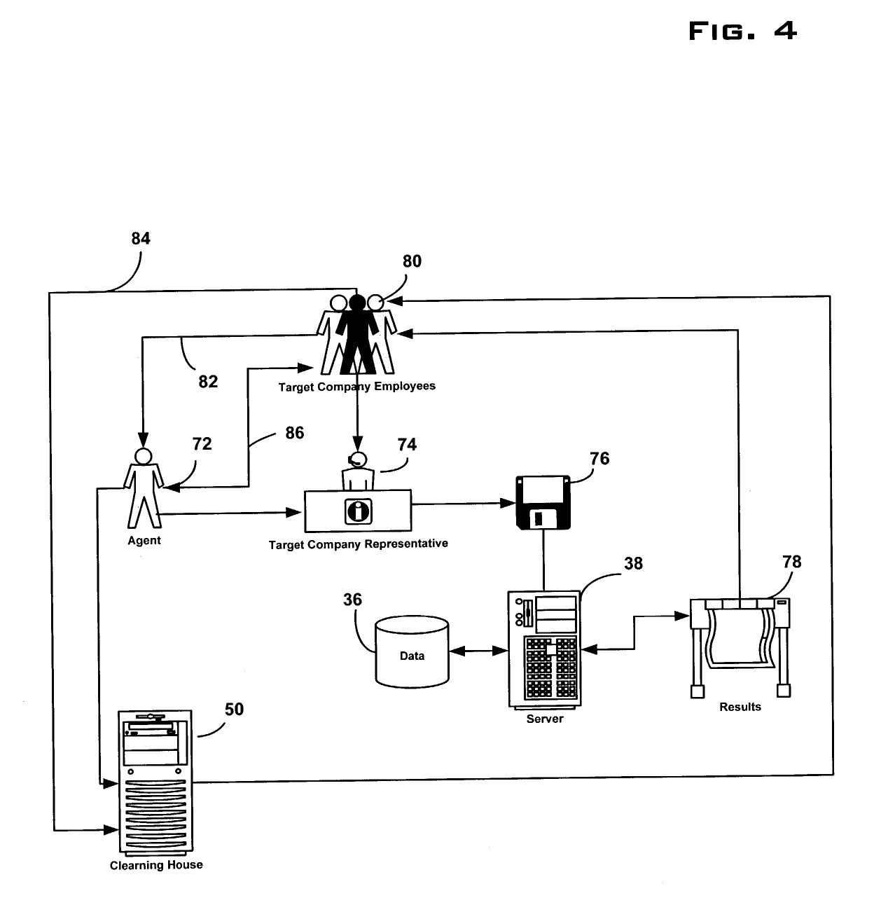

Referring now to FIG. 4, the dataflow at the respective stages of the process are further illustrated. An agent 72 who is responsible for contacting the target company representative 74 receives employee and VGTL data 76 from the target company. The data is processed as described above through computer readable instructions embodied in a computer readable medium of server 38 and the employee information is contained with employee data 36. The computer readable instructions provide output 78 as described above containing the comparison of the VGTL with an IPT policy. This information can be presented in various formats, tabular, individually, written electronically, graphically or collective to either the target company representative or individual employees 80. The agent, in the preferred embodiment, performs such presentation. Once the employee has received the information and decides to purchase an IPT policy, the agent and employee can meet and exchange information for an IPT application along path 82. The agent transmits this information, electronically or otherwise, to clearing house 50 for further processing or can process the application internally to the agents company according to the infrastructure of each agent. In the preferred embodiment, a clearing house is used to facilitate the processing of many policies and quick turn-around with the determination for coverage for each applicant. Additionally, health information is transmitted from the employee to clearing house 50 through path 84. Upon receiving the application and health information, an IPT policy can be provided to the employee. Additionally, the premiums can be received upon the meeting between the agent and the employee and may be in the format of credit cards, direct draft, or other monetary forms. This allows all the necessary information and payment transactions to occur at the same time.

An additional benefit of this invention is that the agent is now in a position to provide additional services to the employees. The agent has removed the burden of educating and informing the employees of future benefits that may be available for that employee. Therefore, this invention allows the administration of the IPT as well as the introduction of other benefits to fall on the shoulders of the agents and not just the target company. Agents can now contact employees through direct mail, e-mail, intranets, or the Internet to provide these additional services. Through the use of credit cards or direct drafts, the IPT can be funded without payroll deductions that significantly reduce the administrative costs of the target company.

While a preferred embodiment of the invention has been described using specific terms, such description is for illustrative purposes only, and it is to be understood that changes and variations may be made without departing from the spirit or scope of the following claims.

What is claimed is:

1. A system for analyzing insurance policies to determine a more beneficial insurance plan for an employee comprising:
a computer readable medium;
a database contained within said computer readable medium having term life insurance information including term life premium information and term life benefits information; and,
a set of computer readable instructions contained within said computer readable medium for receiving individual employee information, storing said employee information within said computer readable medium, receiving group life insurance information having group premium information and group benefits information, storing said group life insurance information within said computer readable medium, retrieving said term life benefits information according to said group premium information and said employee information, providing a comparison of said term life benefits information and said group benefits information at a group premium amount according to said group premium information so that the employee can be shown which life insurance policy provides the most advantageous benefits for said group premium amount.

2. The system of claim 1 wherein said computer readable instructions include instructions for retrieving said employee information from said computer readable medium and providing a term life insurance policy application according to said employee information so that said employee can apply for term life insurance.

3. The system of claim 2 wherein said computer readable instructions include instructions for transmitting said term life insurance policy application to an underwriting entity so that said application can be processed.

4. The system of claim 3 wherein said computer readable instructions include instructions for transmitting said term life insurance policy application electronically to an underwriting entity.

5. A system for analyzing insurance polices to determine a more beneficial insurance plan for an employee comprising:
a computer readable medium;
a database contained within said computer readable medium having term life insurance information including term life premium information and term life benefits information; and,
a set of computer readable instructions contained within said computer readable medium for receiving individual employee information, storing said employee information within said computer readable medium, receiving group life insurance information having group premium information and group benefits information, storing said group life insurance information within said computer readable medium, retrieving said term life premium information according to said group benefits information and said employee information, providing a comparison of said term life premium information and said group premium information at a group benefit amount according to said group benefits information so that the employee can be shown which life insurance policy provides the most advantageous premiums for said group benefit amount.

6. The system of claim 5 wherein said computer readable instructions include instructions for retrieving said employee information from said computer readable medium and providing a term life insurance policy application according to said employee information so that said employee can apply for term life insurance.

7. The system of claim 6 wherein said computer readable instructions include instructions for transmitting said term life insurance policy application to an underwriting entity so that said application can be processed.

8. The system of claim 7 wherein said computer readable instructions include instructions for transmitting said term life insurance policy application electronically to an underwriting entity.

9. A system for analyzing insurance to determine a more beneficial insurance plan for an employee comprising:
a computer readable medium having term life insurance information; and,
a set of computer readable instructions embodied within said computer readable medium for receiving individual employee information, storing said employee information within said computer readable medium, receiving group life insurance information having group premium information and group benefits information, storing said group life insurance information within said computer readable medium, determining term life insurance premiums according to said employee information and said term life insurance information, providing a comparison of term life insurance benefits and group life insurance benefits at a group premium amount so that the employee can be shown which life insurance policy provides the most advantageous benefits for said group premium amount.

10. The system of claim 9 wherein said computer readable instructions include instructions for retrieving said employee information from said computer readable medium and providing a term life insurance policy application according to said employee information so that said employee can apply for said term life insurance.

11. The system of claim 10 wherein said computer readable instructions include instructions for transmitting said term life insurance policy application to an underwriting entity so that said application can be processed.

12. The system of claim 11 wherein said computer readable instructions include instructions for transmitting said term life insurance policy application electronically to an underwriting entity.

13. A system for analyzing insurance to determine a more beneficial insurance plan for an employee comprising:
a computer readable medium having term life insurance information; and,
a set of computer readable instructions embodied within said computer readable medium for receiving individual employee information, storing said employee information within said computer readable medium, receiving group life insurance information having group premium information and group benefit information, storing said group life insurance information within said computer readable medium, determining term life insurance benefits according to said employee information and said term life insurance information, providing a comparison of term life insurance premiums and group life insurance premiums at a group benefit amount so that the employee can be shown which life insurance policy provides the most advantageous premiums for said group benefit amount.

14. The system of claim 13 wherein said computer readable instructions include instructions for retrieving said employee information from said computer readable medium and providing a term life insurance policy application according to said employee information so that said employee can apply for said term life insurance.

15. The system of claim 14 wherein said computer readable instructions include instructions for transmitting said term life insurance policy application to an underwriting entity so that said application can be processed.

16. The system of claim 15 wherein said computer readable instructions include instructions for transmitting said term life insurance policy application electronically to an underwriting entity.

17. A method for analyzing insurance from term life insurance information to determine a more beneficial insurance plan for an employee comprising:
receiving individual employee information;
receiving group life insurance information having group premium information and group benefits information;
determining insurance benefits of an individual term life insurance policy according to said group premium information of said group life insurance information, said employee information, and said term life insurance information; and,
providing a comparison of term life insurance benefits for a group premium amount and group life insurance benefits so that the employee can be shown which life insurance policy provides the most advantageous benefits for the group premium amount.

18. The system of claim 17 including the step of creating a term life insurance policy application according to said employee information so that said employee can apply for term life insurance.

19. The system of claim 18 including the step of transmitting said term life insurance policy application to an underwriting entity so that said application can be processed.

20. The system of claim 19 including the step of providing a term life insurance policy to the employee upon approval of said term life insurance policy application.

21. A method for analyzing insurance from term life insurance information to determine a more beneficial insurance plan for an employee comprising the steps of:
receiving individual employee information;
receiving group life insurance information having group premium information and group benefit information;
determining insurance premiums of an individual term life insurance policy according to said group benefits information of said group life insurance information, said employee information, and said term life insurance information; and,
providing a comparison of term life insurance premiums for a group benefit amount and said group life insurance premiums so that the employee can be shown which life insurance policy provides the most advantageous premium for the group benefit amount.

22. The system of claim 21 including the step of creating a term life insurance policy application according to said employee information so that said employee can apply for term life insurance.

23. The system of claim 22 including the step of transmitting said term life insurance policy application to an underwriting entity so that said application can be processed.
